(19) United States
(12) Patent Application Publication
(10) Pub. No.: US 2011/0207408 A1
(43) Pub. Date: Aug. 25, 2011

(54) PEER TO PEER COMMUNICATION USING DEVICE CLASS BASED TRANSMISSION RULES

(75) Inventor: Fabien Lefebvre, Evrecy (FR)

(73) Assignee: NXP B.V., Eindhoven (NL)

(21) Appl. No.: 13/127,359

(22) PCT Filed: Nov. 3, 2009
(86) PCT No.: PCT/IB09/54872

§ 371 Date: May 3, 2011

(30) Foreign Application Priority Data
Nov. 7, 2008 (EP) 08291043.1
Nov. 3, 2009 (IB) PCT/IB2009/054872

(51) Int. Cl. H04B 7/00

(52) U.S. Cl. 455/41.2

(57) ABSTRACT

Data such as image, sound or other media content is delivered between peer devices over a dedicated peer-to-peer communications medium. According to an example embodiment, data is communicated between peer devices respectively belonging to one of a plurality of device classes respectively identified by a device-class identification (ID). Data is stored to identify communications that are to be carried out between devices having respective IDs, such that each pair of IDs has predefined execution steps based upon operational status of the devices. Based upon the device-class ID pair of two peer devices and an operating status of one or both devices, the devices automatically select and execute a communications approach to communicate data therebetween. This communication can be effected in response to a simple user input (e.g., which is specific to neither data nor transfer direction).

### FIELD OF THE INVENTION

The present invention relates generally to peer-to-peer communications, and to systems and methods for device class-based peer-to-peer communication.

### BACKGROUND OF THE INVENTION

Communicating data such as multimedia content between devices has typically required relatively complex interaction and communication protocols, and in many instances has been cumbersome at best. For example, retrieving image data from a computer, television, or other display device, and storing that data on a hand-held device often requires significant steps and interaction that may involve manual selection and transfer of data. Whether working through computer folders and selections or navigating menus of a television-type display with a remote control, such interaction can be cumbersome and time consuming. Where a cabled (physical) connection such as a USB connection is required, finding the right cable to link a handheld device such as a mobile phone to a computer or video display can be inconvenient.

These and other issues remain challenging to data communications, and in particular to the fast and simple communication of data such as multimedia data.

### SUMMARY OF THE INVENTION

Various aspects of the present invention are directed to methods and systems for communicating data over a peer-to-peer link in a manner that addresses challenges including those discussed above.

Example embodiments of the present invention are directed to communicating between peer devices using communication rules that are predefined for peers having specific device types, in response to a simple initiation event such as a user-input button.

According to another example embodiment, data such as media content is communicated between peer devices over a dedicated peer-to-peer communications medium. Sets of device-class identification (ID) data are stored for respectively identifying each of a plurality of different classes of devices. For each set of device-class ID data, control data is stored for controlling peer-to-peer communications between devices having the device-class ID and other devices having other device-class IDs. A first one of the devices is adapted to receive, from a second one of the devices over the peer-to-peer communications medium, a communication that includes information for identifying a device-class ID for the second device. The first and second devices communicate data between one another over the communications medium, in response to a single user input, using a current operating status of one or both of the devices, and the stored control data.

According to another example embodiment, a device communicates data with other peer devices over a dedicated, local peer-to-peer wireless communications medium, where each of the devices belong to one of a plurality of device classes respectively identified by a device-class identification (ID). The device includes a storage circuit, transceiver and computer processor circuit. The storage circuit stores data identifying a local device-class ID for the device, and different sets of control data for respectively controlling peer-to-peer communications between the device and other devices according to the respective device-class IDs of the devices. The transceiver wirelessly communicates with peer devices on the wireless communications medium. The computer processor circuit is connected to the transceiver and programmed to execute the following, in response to a single user input:

send the local device-class ID and data identifying a current operating status of the device over the wireless communications medium via the transceiver,

receive, from a remote one of the peer devices and via the transceiver, a device-class ID and a current operating status for the remote device,

retrieve a set of control data for controlling communications between devices respectively having the local and remote device-class IDs, and

facilitate the communication of data between the devices over the wireless communications medium, via the transceiver, according to the retrieved set of control data and the current operating status of at least one of the devices.

Other embodiments are directed to electronic circuits and devices for communicating data such as media content in accordance with predefined device-pair rules and the above-discussed embodiment.

The above summary is not intended to describe each embodiment or every implementation of the present disclosure. The Figures and detailed description that follow more particularly exemplify various embodiments.

### BRIEF DESCRIPTION OF THE DRAWINGS

The invention may be more completely understood in consideration of the following detailed description of various embodiments of the invention in connection with the accompanying drawings, in which:

FIG. 1 shows a system and approach for communicating media data between devices, according to an example embodiment of the present invention; and

FIG. 2 shows a device for wirelessly communicating image data with remote devices, according to another example embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention including aspects defined in the claims.

### DETAILED DESCRIPTION OF THE DRAWINGS

The present invention relates to systems and methods for peer-to-peer communications. While the present invention is not necessarily limited to such approaches, various aspects of the invention may be appreciated through a discussion of examples using these and other contexts.

In connection with various example embodiments, a peer-to-peer communications approach involves establishing device-communication rules for automatically determining and implementing the communication of data between devices based upon the respective device class types. A class type is communicated between peer devices, with the respective class types being used to identify one or more potential communication rules. In response to an automated or relatively simple manual (e.g., one-click) communication initiation input, data is communicated between peer devices based upon the predefined communication rules corresponding to the class-type pair of the devices and, where appropriate, current operational aspects of one of the devices.

In another embodiment, data is communicated between peer devices over a dedicated peer-to-peer communications medium. Sets of device-class identification (ID) data are stored for respectively identifying each of a plurality of different classes of devices. For each set of device-class ID data, control data is stored for controlling peer-to-peer communications between devices having the device-class ID and other devices having other device-class IDs (i.e., between two devices, each having their respective class IDs). The control data thus includes data that can be used to characterize read and/or write functions of communicating devices.

Communication between two peer-to-peer devices is carried out as follows, using the stored device-class ID data. At a first one of the devices, a communication sent from a second one of the devices over the peer-to-peer communications medium is received and used to identify a device-class ID relationship between the two devices. That is, the communication generally includes information for identifying a device-class ID for the second device, and the first device knows or otherwise uses data indicating its own device-class ID type. These respective device-class IDs form an ID-class pair relationship between the two devices that is used to determine a communication approach between the two devices, as reflected in the stored ID-based control data.

In response to a single user input, data is communicated between the first and second devices over the communications medium according to a current operating status of one of the devices and the stored control data for the ID-class pair. Generally, this involves one of the devices communicating data over a predefined channel and the other of the devices receiving the data, and may involve using a directed antenna or other approach to ensure communications. In this context, a user need not necessarily specify a data type, communication approach, or provide other control inputs. A simple input (e.g., single push of a button) can initiate the transfer of data that is carried out between devices based upon the device ID-pairs, such as by transferring data for a current image from a television display as a source to a mobile telephone as a receiver.

Where the communication is wireless, the devices can respectively communicate over a local wireless channel without necessarily implementing security or other complex communication schemes, by limiting the communication to the immediate vicinity (e.g., using a 60 Hz signal with the devices that are located within a few meters of one another). In some applications, the devices must be within a meter or two when the hand-held device operates on relatively low power, and in other applications, the devices can be up to about 10 meters from one another, where adequate power is available.

The device-class ID data may include a variety of different device classes that suit different device types and interaction types with the devices. For instance, the device-class ID data may classify devices according to processing, display or audio capabilities of a device to determine whether the device can provide or receive certain types of data. The device-class ID data may also classify devices according to an expected use of a device as specific to a type of device or a user's intended use. Devices may be classified as a source-only device, a receive-only device, or as a device the can be a source or receiver depending upon the class of a device with which it may communicate.

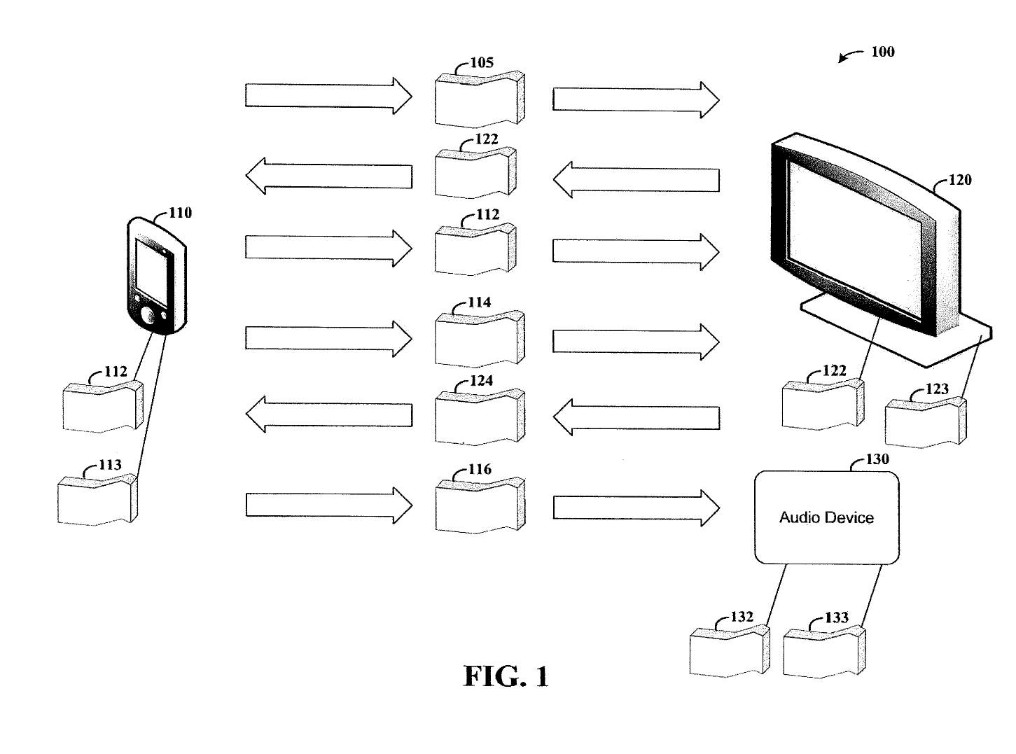

Turning now to the Figures, FIG. 1 shows a system 100 and approach for communicating media data between devices, according to another example embodiment of the present invention. The system 100 is shown with a mobile hand-held device 110, a video display device 120 (e.g., a television) and an audio device 130, which communicate over a local, peer-to-peer wireless communication link. The system may operate with either or both of the video display device 120 and audio device 130 (or other similar devices), with the shown devices chosen as examples to facilitate discussion. In addition, the following discussion involves communications between the hand-held device 110 and the video display device 120, or between the hand-held device 110 and audio device 130, but may be applied for similar communications between the other of the devices 120 and 130.

Device class ID data 112, 122 and 132 is respectively stored at each of the hand-held device 110, video display device 120 and audio device 130 (or other audio playback device) for identifying the device class ID for each of the devices and, correspondingly, identifying a device-class ID pair for controlling communications with each device. Each of the devices 110, 120 and 130 is also programmed to communicate data (send and/or receive) in response to a communication request and, where appropriate, according to its own device-class ID and the device-class ID of the device with which it is communicating.

The devices 110, 120 and 130 communicate media data in one or more of a variety of manners. The hand-held device 110 is programmed with control data 113, relating to device-class ID pairs, which directs the device to communicate data according to the device-class ID of the device with which it is communicating. Each of the devices 120 and 130 is also respectively programmed with similar control data 123 and 133. The control data at each device either specifies device-class ID pairs for controlling communications, or specifies a fixed communication for devices that operate independently of any communication pair (e.g., a send-only device).

In this context, the control data may specify one or more of a variety of communications controls for communicating between the hand-held device 110 and either the display device 120 or the audio device 130. For example, in one implementation, the hand-held device 110 is programmed to receive and display image data received from a video display device having the device-class ID of the video display device 120. In another implementation, the hand-held device 110 is programmed to communicate video or audio data to a video display device having the device-class ID of the video display device 120. Regarding the audio device 130, the hand-held device may be programmed to receive audio data corresponding to an audio track currently playing at the audio device 130, or to send an audio track, currently playing at the hand-held device, to the audio device 130. If a communication fails, the receiving device can request a retransmission.

In one embodiment, video data at the display device 120 is communicated for display at the hand-held device 110. The display device 120 provides its device class ID data 122 to the hand-held device 110 over the local wireless link. In some implementations, the display device 120 generates the discovery data 105 automatically and without prompting, such as by broadcasting the discovery data at an interval, so that devices in the vicinity of the display device 120 may receive the signal. In other implementations, the hand-held device 110 generates a device discovery communication 105, which effectively prompts the video display 120 to send device-class ID data 122 to the hand-held device 110.

The hand-held device 110 uses the device-class data 122 for the display device 120 and the device-class data 112 together with control data 113 for the device-class ID pair (data 112 and 122) to control communications between the devices. In one implementation, the control data for the device-class ID pair 112/122 specifies that the hand-held device acts as a receiving device when in the vicinity of the video display device 120, to receive an image currently displayed thereupon. In response to a single input at the hand-held device 110 (e.g., a single button used to simply initiate any type of send and/or receive communications controlled according to the control data), the hand-held device automatically sends transfer request data 114 to the video display device 120. In response to the transfer request data 114, the video display device 120 sends content 124 that includes data for an image currently displayed at the device 120. In this regard, a user at the hand-held device 110 may obtain a currently-displayed image on the video display device 120 simply by pressing a universal-type input button (or display button on a touch screen) without necessarily navigating menus or otherwise controlling the communications. Moreover, the communication of content is relatively instantaneous, as the communications approach is predetermined and carried out over a robust local wireless link (e.g., a 60 Hz link)

The above-discussed example involving the communication of a currently-displayed image at the video display 120 to the hand-held device 110 can be carried out in other manners. For instance, the transfer request 114 may be omitted where the video display device 120 is simply programmed to generate content 124 (image data) in response to any input from the hand-held device 110 (e.g., where the video display device is a send-only device). In this regard, the video display device 120 may communicate currently-displayed image data in response to the device discovery request 105 (e.g., where the discover request 105 is sent only in response to a user input to initiate communications at the hand-held device). In other instances, the device discovery request 105 is omitted where the video display device automatically generates or broadcasts its device class ID 122.

In other implementations, the hand-held device 110 also communicates its device-class ID data to the video display device 120, which uses the device-class ID data together with its own device-class ID data to identify appropriate control data 123 to use in communicating with the hand-held device 110. For example, where the video display device 120 is programmed to display an image received from such a hand-held device, the control data may specify that the video display device act as a receiver under certain operating circumstances, such as when the hand-held device is currently displaying an image. Control data 123 may thus specify that the video display device wait for a transfer request 114 before sending image data, and receives image content 116 if sent by the hand-held device 110. Accordingly, the control data 113 at the hand-held device 110 may specify that the hand-held device 110 automatically send image data 116 to the video display device 120 when an image is displayed at the hand-held device at the time that a user at the device 110 initiates a communication (e.g., for displaying a picture on the video display device). The control data 113 can accordingly specify that image data be requested (via request 114) from the video display device when no image is displayed at the hand-held device. In this regard, operational conditions of the hand-held device 110 are used to determine the type of data transfer to execute, with a single input at the hand-held device used to automatically initiate data transfer.

According to other embodiments involving devices that can be a data source or receiver, a second or directed first input may be obtained from a user. For instance, the hand-held device 110 may operate to send or receive in response to a different single initial input, or a second input can be obtained where “receive” or “send” operations are available to a particular device.

Similar approaches may be carried out to effect the transfer of audio data between the hand-held device 110 and the audio device 130. For instance, once device-type ID data has been established between the devices, if the hand-held device 110 is currently playing an audio track, the control data 113 may specify that the track be communicated to the audio device 130. If the hand-held device 110 is not playing an audio track, the control data 113 may specify that the device request audio data currently playing on the audio device 130.

In another embodiment, the display 120 is part of a personal computer system (PC) that displays image data for software applications (e.g., word processing documents, Internet web pages) on the display 120, and the transfer of data therebetween is based upon an operating status of the hand-held device 110. For instance, when a communication transfer is initiated by the hand-held device 110 (e.g., a user initiating a transfer at a mobile phone) and the PC is displaying information for a file used by a currently-operating application (e.g., a word-processing file), the PC transfers the file, or a displayed image corresponding to the file, to the hand-held device. For instance, if the PC is displaying a word-processing type of file, the corresponding word-processing file can be sent to the hand-held device. If the hand-held device 110 is displaying an image or generating other media content when the communication transfer is initiated, the hand-held device sends the displayed image or media content to the PC for displaying at 120. To facilitate this transfer, the hand-held device 110 communicates its operating status and its device-class ID to the PC/display 120, which uses the status together with the device-class ID pair (for 110 and 120) to determine whether to send or receive image data. The hand-held device 110 similarly determines whether to send or receive image data, based upon its own operating status and the device-class ID pair gleaned from information provided by the PC (i.e., as described above). The operating status of the PC can be similarly used to determine the direction of any transfer, such as by communicating data only when a media application is running on the PC (e.g., an image displaying or audio playback application). Where both devices are displaying or providing data that is amenable for transfer, a default transfer approach may be carried out wherein transfer is automatically from one or the other devices, or wherein no transfer is effected as an error condition. A default transfer in this context may involve, for example, transferring data from a slave device to a master device, such as wherein the hand-held device 110 is the master and, in response to an input thereat, the display device 120 sends image data to the hand-held device in a default transfer mode.

These and other scenarios are readily implemented, for example, by executing an algorithm set for the particular device-class ID pair to determine an appropriate communication scheme. With both devices in a peer-to-peer environment operating on the same algorithms, transfer is effected automatically, relatively instantly and securely (e.g., with the transmission limited to within a few meters).

In some applications, one or more of the devices involved in a communication exchange as described herein carries out additional functions corresponding to the data and in response to a single input, according to control data for the device. For instance, the video display device 120 may be programmed with control data that instructs the device to automatically display image data received from the hand-held device, after receiving the image data and with no further input.

The control data 113, 123 and 133 can also specify forbidden transfer scenarios, such as when neither of two peer-to-peer devices has data available, or when a type of data cannot be resolved. For instance, where two peer devices are mobile phones and neither is operating on data that can be transferred (e.g., neither is displaying an image, displaying personal information or playing an audio track), there is no data transfer that can be resolved and thus no transfer is carried out.

In some embodiments and as may further be applicable to FIG. 1, the respective devices also communicate data that identifies a version of a communications (control) standard that the device supports, with each device in each peer-to-peer pair reverting to an oldest one of the standards to ensure that both devices are operating on a common standard for identifying device classes.

In other embodiments, devices such as those in FIG. 1 are programmed with control data according to media rights protection standards, and communicate accordingly therewith. For example, where content is protected for video displayed on the display device 120 (e.g., for HD videos), transfer of the content may be altered (e.g., altering the content to low definition) or prohibited altogether.

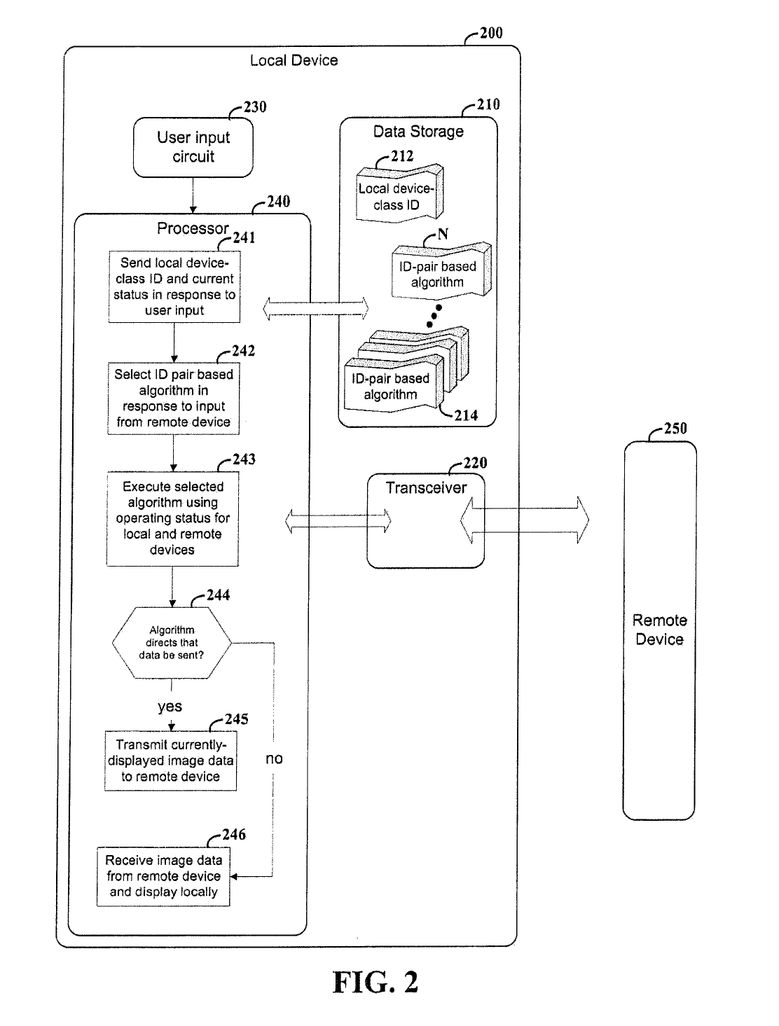

FIG. 2 shows a local device 200 for wirelessly communicating image data with remote devices, according to another example embodiment of the present invention. The device 200 includes a data storage circuit 210, a transceiver 220, a user input circuit 230 and a processor 240. A remote device 250 is shown by way of example and is referred to in the following for ease of discussion, yet a plurality of such devices are contemplated, each device falling into a particular one of various device classes.

The data storage circuit 210 stores a local device-class ID for the local device 200, and a plurality of algorithms 214-N, each based upon a specific device-class ID pair, and including an algorithm for ID pairs including the local device-class ID and each of a plurality of other device-class IDs. Each algorithm respectively identifies fixed communications controls for controlling the wireless communication of image data between the local and remote devices 200 and 250, using the transceiver 220 for executing the wireless communications. Generally, the transceiver 220 operates on a high-bandwidth frequency, such as a 60 Hz frequency, amenable to the rapid transfer of image content (e.g., still images or video) over a local wireless link of relatively limited range (e.g., less than a few meters).

The user input circuit 230 includes one or more of a mechanical-type button such as a pushbutton on a mobile telephone, and other input devices such as a touch screen. The processor 240 is responsive to the user input circuit 230 by initiating a communication session between the local and remote devices 200 and 250.

The processor 240 effects the transfer of image data between the devices 200 and 250 using one or more of a variety of approaches, such as those described above. The indicated functions 241-246 exemplify one such approach, as follows. At block 241, the local device-class ID data 212 and current operating status data for the local device 200 (e.g., is the device displaying an image?) is transmitted via the transceiver 220, for receipt by any remote device in the local vicinity (e.g., within about three meters).

In response to a device-class ID communicated by the remote device 250 (responsive to the initial transmission from the local device 200), a matching one of algorithms 214-N is selected at block 242, based on the ID-pair of the local and remote devices. The selected algorithm is executed at block 243, using an operating status of the local and remote devices (e.g., is either device displaying an image or video?).

If the executed algorithm directs that data be sent at block 244, image data currently displayed at the local device 200 is transmitted to the remote device 250 via the transceiver and the local wireless link at block 245. If the algorithm does not direct that data be sent at block 244, any image data received from the remote device 250 is displayed at block 246.

Corresponding operational functions may also be carried out at the remote device 250. For example, where the local device 200 initiates a communications session via the user input circuit 230, the remote device 250 may respond by similarly selecting and executing an algorithm based upon the device-class ID pair for the two devices, which may direct the remote device to transmit currently-displayed image data. These approaches may be implemented, for example, where the local device 200 is a mobile telephone device and the remote device 250 includes one of a television-type or computer-type video display.

One approach to communicating data in accordance with one or both of FIG. 1 and FIG. 2 and related embodiments is carried out as follows, using a software-programmed computer circuit to operate on respective algorithms, and a broad-band transceiver to wirelessly communicate with devices in the immediate vicinity. Media data is wirelessly communicated between a plurality of different classes of devices. Each of the devices is provided with or otherwise stores a device class ID to identify its class, as well as algorithms for respectively controlling communications with devices having each of a plurality of device class IDs. That is, an algorithm is stored for each device-class ID pair for all devices with which the device can communicate. As an example in this context, for device classes A, B, C, D and E and for a device having device class ID “A,” an algorithm is stored for each of the following device-class ID pairs: “A-A,” “A-B,” “A-C,” “A-D” and “A-E.” For two devices within wireless range of one another, one of the devices initiates a wireless communication in response to an input such as a user-pressed dedicated mechanical or touch-screen button. The communication includes the device class ID of the device initiating the communication, and may also include its operating status. In response to the wireless communication, the other of the two devices wirelessly transmits its device class ID and, in some applications, its current operating status to the initiating device.

With both devices having the device-class ID (and, where appropriate, operating status) of the other device, each device uses an appropriate algorithm for the device-class ID pair and, based upon those pairs (and, in some instances, operating status), one of the devices transmits media content to the other of the devices.

The above steps can thus be carried out automatically, in response to a single user input at one of the devices and using algorithms that implement one or more of device class ID data and operating status for one or both devices.

In addition to the above, the various processing approaches described herein can be implemented using a variety of devices and methods including general purpose processors implementing specialized software, digital signal processors, programmable logic arrays, discrete logic components and fully-programmable and semi-programmable circuits such as PLAs (programmable logic arrays). For example, the above algorithms are executed on a microcomputer (a.k.a. microprocessor) in connection with certain embodiments, and as may be implemented as part of one or more of the devices shown in the Figures.

While the present invention has been described above, in the Figures and in the claims that follow, various systems and approaches may be implemented in connection with and/or in addition to the example embodiments described above. For instance, embodiments described in reference to the Figures may be implemented using different systems and approaches. Embodiments described without specific reference to the Figures may be implemented with the Figures. Other embodiments involve using different approaches in combination with those described. In this regard, those skilled in the art will recognize that many changes may be made thereto without departing from the spirit and scope of the present invention.

1. A method for communicating data between peer devices over a dedicated peer-to-peer communications medium, each of the peer devices belonging to one of a plurality of device classes respectively identified by a device-class identification (ID), the method comprising:
at each of the devices,
storing data identifying a device-class ID for the device,
storing different sets of control data for respectively controlling peer-to-peer communications between the device and other devices according to the respective device-class IDs of the devices;
at a first one of the devices,
receiving, from a second one of the devices over the peer-to-peer communications medium, a communication that includes information for identifying a device-class ID for the second device, and
in response to a single user input, communicating data between the first and second devices over the communications medium according to
a current operating status of at least one of the devices, and
one of the stored sets of control data for controlling communications between devices respectively having the device-class ID of the first device and the device-class ID of the second device.

2. The method of claim 1, wherein
the first device is a mobile hand-held device,
the second device is a video display device, and
communicating data between the first and second devices according to a current operating status of one of the devices includes wirelessly communicating a currently-displayed image from a television broadcast signal displayed at the video display device to the mobile hand-held device.

3. The method of claim 1, wherein
the first device is a mobile hand-held device,
the second device is a computer having a display, and
communicating data between the first and second devices according to a current operating status of one of the devices includes wirelessly communicating currently-used data from an application running on the computer to the mobile hand-held device.

4. The method of claim 1,
further comprising,
at the first device, sending an initiation transmission over a wireless communications medium in response to the single user input, and
at the second device, monitoring the wireless communications medium to detect the initiation transmission and, in response to the detected transmission, transmitting a wireless communication that includes information for identifying a device-class ID for the second device,
wherein communicating data between the first and second devices in response to a single user input includes
at the first device, sending a communication request to the second device over the wireless communications medium, and
at the second device, communicating data to the first device over the wireless communications medium.

5. The method of claim 1, wherein communicating data between the first and second devices includes communicating over a local wireless communication link having an operable distance of less than about 10 meters.

6. The method of claim 1, wherein communicating data between the first and second devices includes using a directed antenna to communicate over a wireless link exhibiting attenuation that is proportional to a square of the wavelength.

7. The method of claim 1, wherein
the first device also communicates its device-class ID to the second device, and
the second device uses the device-class ID of the first device to identify control data for communicating with the first device.

8. The method of claim 1, wherein communicating data between the first and second devices includes forbidding a communication in response to neither device operating on data amenable for transfer.

9. The method of claim 1, wherein communicating data between the first and second devices includes communicating data according to control data specifying a data type to communicate in accordance with media rights standard data.

10. The method of claim 1, further comprising, after communicating data between the first and second devices, operating one of the devices to provide data for use at the device in response to the control data specifying the operation.

11. A software-programmed computer circuit to store and execute an algorithm to carry out the steps of claim 1.

12. A device for communicating data with other devices over a dedicated, local peer-to-peer wireless communications medium, each of the devices belonging to one of a plurality of device classes respectively identified by a device-class identification (ID), the device comprising:
a storage circuit to store data identifying a local device-class ID for the device, and different sets of control data for respectively controlling peer-to-peer communications between the device and other devices according to the respective device-class IDs of the devices;
a transceiver to wirelessly communicate with peer devices on the wireless communications medium; and
a computer processor circuit connected to the transceiver and programmed to, in response to a single user input,
send the local device-class ID and data identifying a current operating status of the device over the wireless communications medium via the transceiver,
receive, from a remote one of the peer devices and via the transceiver, a device-class ID and a current operating status for the remote device,
retrieve a set of control data for controlling communications between devices respectively having the local and remote device-class IDs, and
facilitate the communication of data between the devices over the wireless communications medium, via the transceiver, according to the retrieved set of control data and the current operating status of at least one of the devices.

13. The device of claim 12, wherein
the device is a television device having a display,
the computer processor circuit is programmed to, in response to a single user input that includes an initiation communication sent to the television device over the wireless communications medium from a mobile hand-held device, the initiation communication specifying a device-class ID and current operating status of the mobile hand-held device,
send file data for a currently-displayed image at the television device to the mobile hand-held device in response to the operating status of the mobile hand-held device indicating that the hand-held device is not displaying an image, and
receive and display image data for an image currently displayed at the mobile hand-held device, in response to the operating status of the mobile hand-held device indicating that the hand-held device is displaying an image.

14. The device of claim 12, wherein
the device is a personal computer (PC) having a display,
the computer processor circuit is programmed to, in response to a single user input that includes an initiation communication sent to the PC over the wireless communications medium from a mobile hand-held device, the initiation communication specifying a device-class ID and current operating status of the mobile hand-held device,
send file data, from an application running on the PC for a currently-displayed image, to the mobile hand-held device in response to the operating status of the mobile hand-held device indicating that the hand-held device is not displaying an image, and
receive and display image data for an image currently displayed at the mobile hand-held device, in response to the operating status of the mobile hand-held device indicating that the hand-held device is displaying an image.

15. The device of claim 12, wherein the transceiver is adapted to communicate with peer devices using a local wireless communication link having an operable distance of less than about 5 meters.

16. The device of claim 12, further including a directed antenna to communicate data over a wireless link exhibiting attenuation that is proportional to a square of the wavelength of the communication.

17. The device of claim 12, wherein the computer processor circuit is programmed to alter media data communicated from the device in response to stored media rights standard data.
